(19) United States
(12) Patent Application Publication
(10) Pub. No.: US 2025/0030236 A1
(43) Pub. Date: Jan. 23, 2025

(54) OVER-CURRENT PROTECTION DEVICE

(71) Applicant: Polytronics Technology Corp., Hsinchu (TW)

(72) Inventors: Hsiu-Che YEN, Taoyuan City (TW); Chingting CHIU, Taoyuan City (TW); Chia-Yuan LEE, Hsinchu City (TW); Chen-Nan LIU, Pitou Township (TW); Cheng-Yu TUNG, Tainan City (TW); Yung-Hsien CHANG, Douliu City (TW); Yao-Te CHANG, Linnei Township (TW); Fu-Hua CHU, TAIPEI CITY (TW)

(21) Appl. No.: 18/390,734

(22) Filed: Dec. 20, 2023

(30) Foreign Application Priority Data
Jul. 12, 2023 (TW) 112125969

(51) Int. Cl. H02H 9/02; H01C 7/02; H01C 7/13

(52) U.S. Cl. CPC H02H 9/026; H01C 7/027; H01C 7/13

(57) ABSTRACT

An over-current protection device includes an electrode layer and a heat-sensitive layer. The heat-sensitive layer exhibits a positive temperature coefficient (PTC) characteristic, and is laminated between a top metal layer and a bottom metal layer of the electrode layer. The heat-sensitive layer includes a polymer matrix and a conductive filler. The polymer matrix includes a first fluoropolymer and a second fluoropolymer. The weight average molecular weight of the second fluoropolymer ranges from 630000 g/mol to 1100000 g/mol. The conductive filler is dispersed in the polymer matrix, thereby forming an electrically conductive path in the heat-sensitive layer.

### BACKGROUND OF THE INVENTION

### (1) Field of the Invention

The present application relates to an over-current protection device, and more specifically, to a low-resistivity over-current protection device applied to locked rotor protection.

### (2) Description of the Related Art

Because the electrical resistance of conductive composite materials having a positive temperature coefficient (PTC) characteristic is very sensitive to temperature variation, they can be used as the materials for current sensing devices and have been widely applied to over-current protection devices or circuit devices. More specifically, the electrical resistance of the PTC conductive composite material remains extremely low at normal temperatures, so that the circuit or battery cell can operate normally. However, when an over-current or an over-temperature situation occurs in the circuit or cell, the electrical resistance will instantaneously increase to a high electrical resistance state (e.g., at least above 10⁴Ω), which is the so-called “trip”. Therefore, the over-current will be eliminated so as to protect the cell or the circuit device.

The basic structure of the over-current protection device consists of a PTC material layer with two electrodes bonded to two opposite sides of the PTC material layer. The PTC material layer includes a matrix and a conductive filler. The matrix consists of at least one polymer, and the conductive filler is uniformly dispersed in the matrix and is used as an electrically conductive path. In order to meet the requirement of overheating protection at higher temperature, a fluoropolymer (e.g., polyvinylidene difluoride) is generally selected as the major constituent in the matrix. In addition, the conductive filler can be roughly divided into two types according to its composition: the first type of conductive filler consists of carbon black and at least one metal compound, while the second type of conductive filler consists of carbon black. The first type of conductive filler may be referred to as “conductive filler for low electrical resistivity,” and the over-current protection device includes this type of conductive filler may be referred to as “over-current protection device with low electrical resistivity,” or simply the LR over-current protection device. Conventionally, although LR over-current protection device, whose major constituent of the matrix is made of PVDF (referred to as “PVDF LR over-current protection device” hereinafter), has better capability for electrical conduction, the issue of thermal instability exists therein. More specifically, during numerous cycles of increase and decrease in temperature (i.e., thermal shock), the electrical resistance of the conventional PVDF LR over-current protection device becomes higher and higher, and significantly changes after many times of temperature increase. The aforementioned situation is particularly obvious in the temperature range before the trip event occurs, which leads to the decrease of current flow and compromises the normal operation of the electronic apparatus to be protected. It is understood that as miniaturization becomes a trend in over-current protection devices, the issue of thermal instability could become more severe with decreasing device size.

Accordingly, there is a need to improve the resistance stability of the LR over-current protection device.

### SUMMARY OF THE INVENTION

The present invention provides an over-current protection device with low resistivity and high stability in electrical resistance. The over-current protection device has an electrode layer and a heat-sensitive layer, achieving the protection of electronic apparatus through the positive temperature coefficient (PTC) characteristic exhibited by the heat-sensitive layer. Notably, the heat-sensitive layer of the present invention includes two fluoropolymers (referred to as “first fluoropolymer” and “second fluoropolymer” hereinafter), and the weight average molecular weight of the second fluoropolymer is controlled within the range of 630000 g/mol to 1100000 g/mol, thereby minimizing material disturbance in the heat-sensitive layer. Consequently, the electrical resistance of the over-current protection device is less susceptible to temperature shock (i.e., thermal shock) while maintaining low electrical resistivity, making it suitable for devices with large current demands.

In accordance with an aspect of the present invention, an over-current protection device includes an electrode layer and a heat-sensitive layer. The electrode layer has a top metal layer and a bottom metal layer. The heat-sensitive layer contacts the top metal layer and the bottom metal layer, and is laminated therebetween, wherein the heat-sensitive layer exhibits a positive temperature coefficient (PTC) characteristic and includes a polymer matrix and a conductive filler. The polymer matrix includes a first fluoropolymer and a second fluoropolymer, wherein the weight average molecular weight of the second fluoropolymer ranges from 630000 g/mol to 1100000 g/mol. The conductive filler is dispersed in the polymer matrix, thereby forming an electrically conductive path in the heat-sensitive layer.

In an embodiment, the total volume of the heat-sensitive layer is calculated as 100%, and the first fluoropolymer accounts for 12% to 42% and the second fluoropolymer accounts for 1% to 31% by volume.

In an embodiment, the second fluoropolymer is represented by a structural formula (I):

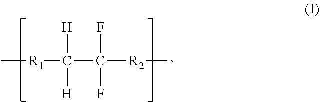

wherein: R₁ and R₂ are selected from the group consisting of CH₂, CF₂, CHF, C₂HF₃, C₂H₂F₂, C₂H₃F, C₂H₄, and C₂F₄; R₁ is different from R₂; and n is at least 9000.

In an embodiment, the weight average molecular weight of the first fluoropolymer ranges from 250000 g/mol to 490000 g/mol.

In an embodiment, the first fluoropolymer has a first melt flow index, and the second fluoropolymer has a second melt flow index lower than the first melt flow index. A difference between the first melt flow index and the second melt flow index ranges from 0.1 g/10 min to 1 g/10 min.

In an embodiment, the first melt flow index ranges from 0.8 g/10 min to 1.4 g/10 min, and the second melt flow index ranges from 0.4 g/10 min to 0.7 g/10 min.

In an embodiment, the first fluoropolymer is polyvinylidene difluoride.

In an embodiment, the polymer matrix further includes a third fluoropolymer selected from the group consisting of polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, vinylidene fluoride-hexafluoropropylene-tetrafluoroethylene terpolymer, and any combination thereof.

In an embodiment, the third fluoropolymer is polytetrafluoroethylene. The total volume of the heat-sensitive layer is calculated as 100%, and polytetrafluoroethylene accounts for 4% to 6% by volume.

In an embodiment, the heat-sensitive layer further includes an inner filler. The inner filler is selected from the group consisting of BaTiO₃, SrTiO₃, CaTiO₃, and any combination thereof.

In an embodiment, the conductive filler includes carbon black and at least one metal compound. The metal compound is selected from the group consisting of tungsten carbide, titanium carbide, vanadium carbide, zirconium carbide, niobium carbide, tantalum carbide, molybdenum carbide, hafnium carbide, titanium boride, vanadium boride, zirconium boride, niobium boride, molybdenum boride, hafnium boride, zirconium nitride, and any combination thereof.

In an embodiment, the over-current protection device has a resistance change ranging from 0.0007Ω to 0.0021Ω when exposed to thermal shock. The over-current protection device has an initial electrical resistance; the over-current protection device has a first electrical resistance when cooled back to room temperature after thermal shock from −40° C. to 85° C. for 300 cycles; and the resistance change is obtained by subtracting the initial electrical resistance from the first electrical resistance.

In an embodiment, the over-current protection device has an electrical resistance ranging from 0.02Ω to 0.03Ω when cooled back to room temperature after the thermal shock from −40° C. to 85° C. for 300 cycles and being applied at 24V/40 A for 3 minutes.

In an embodiment, the over-current protection device has a first resistance-jump ratio ranging from 1.43 to 1.55. The over-current protection device has an initial electrical resistance; the over-current protection device has a second electrical resistance when cooled back to room temperature after being applied at 24V/40 A for 3 minutes; and the first resistance-jump ratio is obtained by dividing the second electrical resistance by the initial electrical resistance.

In an embodiment, the over-current protection device has a power dissipation ranging from 1.5 W to 1.6 W when 24V/40 A is applied to the over-current protection device.

In an embodiment, the over-current protection device has an electrical resistivity ranging from 0.03 Ω·cm to 0.04 Ω·cm.

In an embodiment, the over-current protection device has a second resistance-jump ratio ranging from 2.46 to 2.94. The over-current protection device has an initial electrical resistance; the over-current protection device has a third electrical resistance when cooled back to room temperature after a cycle life test for 100 cycles; and the second resistance-jump ratio is obtained by dividing the third electrical resistance by the initial electrical resistance.

In an embodiment, the over-current protection device has a thermal derating ratio of trip current ranging from 0.6 to 0.7. The thermal derating ratio of trip current is defined as a value by dividing a required trip current of the over-current protection device under 85° C. by a required trip current of the over-current protection device under 23° C.

### BRIEF DESCRIPTION OF THE DRAWINGS

The present application will be described according to the appended drawings in which:

FIG. 1 shows a cross-sectional view of an over-current protection device in accordance with an embodiment of the present invention;

FIG. 2 shows the top view of the over-current protection device shown in FIG. 1;

FIG. 3 shows a three-dimensional view of a motor; and

FIG. 4 shows a cross-sectional view of the motor along the line AA shown in FIG. 3.

### DETAILED DESCRIPTION OF THE INVENTION

The making and using of the presently preferred illustrative embodiments are discussed in detail below. It should be appreciated, however, that the present application provides many applicable inventive concepts that can be embodied in a wide variety of specific contexts. The specific illustrative embodiments discussed are merely illustrative of specific ways to make and use the invention, and do not limit the scope of the invention.

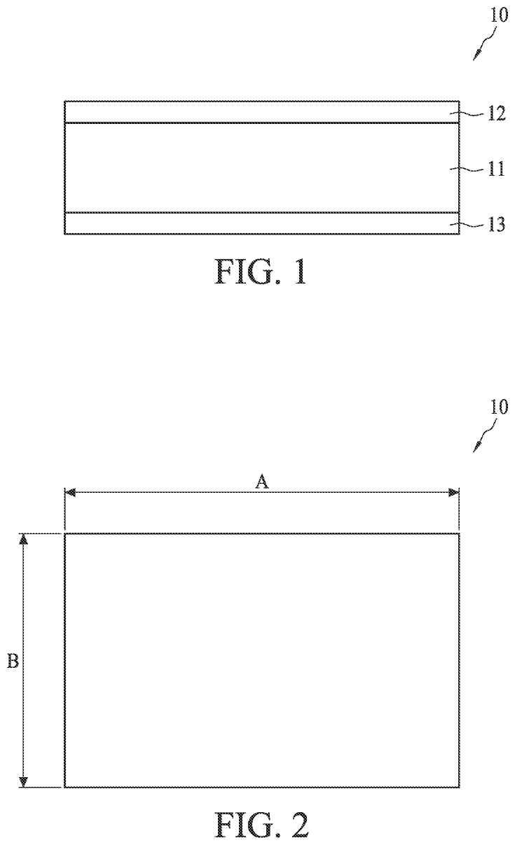

Please refer to FIG. 1. FIG. 1 shows one basic aspect of an over-current protection device 10 of the present invention in cross-sectional view. The over-current protection device 10 includes a heat-sensitive layer 11 and an electrode layer. The heat-sensitive layer 11 has a top surface and a bottom surface, and the electrode layer has a top metal layer 12 and a bottom metal layer 13 attached to the top surface and the bottom surface, respectively. Therefore, the heat-sensitive layer 11 physically contacts the top metal layer 12 and the bottom metal layer 13, and is laminated therebetween. In an embodiment, the top metal layer 12 and the bottom metal layer 13 may be composed of the nickel-plated copper foils or other conductive metals. In addition, the heat-sensitive layer 11 includes a polymer matrix and a conductive filler. The polymer matrix is an electrical insulator sensitive to heat, and the conductive filler is a conductor, by which the heat-sensitive layer 11 exhibits PTC characteristic. The over-current protection device 10 does not operate under normal condition, and therefore the conductive filler is uniformly dispersed in the polymer matrix, and particles of the conductive filler connect to each other in series, thereby forming an electrically conductive path; however, the polymer matrix rapidly expands when the over-current protection device 10 is subject to high temperature, and the particles of the conductive filler are pulled away from each other, thereby cutting off the electrically conductive path in the heat-sensitive layer 11. Before the trip event occurs, the hold current (I-hold) is substantially determined by the thermal stability of the polymer matrix and the type of the conductive filler.

In the present invention, the polymer matrix includes two fluoropolymers, that is, a first fluoropolymer and a second fluoropolymer, respectively. The first fluoropolymer may be the conventional polyvinylidene difluoride having a low weight average molecular weight (M_{w}), which ranges from 250000 g/mol to 490000 g/mol. The second fluoropolymer is a fluoropolymer having a chemical structural formula with skeleton similar to or the same as the first fluoropolymer, and has a high weight average molecular weight ranging from 630000 g/mol to 1100000 g/mol. The first fluoropolymer and the second fluoropolymer together form the structure of interpenetrating polymer network (IPN). More specifically, the conventional over-current protection device includes a single type of fluoropolymer (e.g., single type of PVDF) as the polymer matrix for overheating protection at high temperature; if two fluoropolymers having the same monomer units but different physical/chemical properties (e.g., two different types of PVDF) are used, it often does not result in a significant improvement or leads to a poor performance in electrical characteristics. In the latter case, it is due to complexity in formulation design. With the addition of each new compound, compatibility between such additional compound and the conventional polymer matrix, conductive filler and other inner fillers must be taken into consideration. Even though the additional compound is compatible with the conventional polymer matrix, conductive filler and other inner fillers, the proportion between them needs to be adjusted properly in order to maintain excellent electric characteristics, or otherwise the aforementioned issue of insignificant improvement or poor performance arises. However, the present invention finds that with a proper adjustment of the weight average molecular weight (ranging from 630000 g/mol to 1100000 g/mol) and a proper proportion of the second fluoropolymer, the device's thermal stability in electrical resistance can be greatly improved and the electrical resistivity thereof (i.e., about 0.03 Ω·cm to 0.04 Ω·cm) is lower than that of conventional device. In an embodiment, the weight average molecular weight of the second fluoropolymer ranges from 730000 g/mol to 1000000 g/mol. In another embodiment, the weight average molecular weight of the second fluoropolymer ranges from 800000 g/mol to 900000 g/mol. In a preferred embodiment, the weight average molecular weight of the second fluoropolymer is 880000 g/mol. As for the aforementioned proper proportion, the total volume of the heat-sensitive layer 11 is calculated as 100%, and the first fluoropolymer accounts for 12% to 42% and the second fluoropolymer accounts for 1% to 31% by volume. The amount of the first fluoropolymer may be higher, equal to, or lower than that of the second fluoropolymer. It is noted that the maximum (i.e., 31%) of the second fluoropolymer is lower than the minimum (i.e., 42%) of the first fluoropolymer in the present invention, because the weight average molecular weight of the second fluoropolymer is much higher than that of the first fluoropolymer. If the proportion of the second fluoropolymer is too high, the materials used to manufacture the heat-sensitive layer 11 will exhibit poor flowability, which is unfavorable to the blending process. Therefore, if the amount of the first fluoropolymer is higher than or equal to that of the second fluoropolymer, it facilitates the blending between the polymer and the conductive filler, which is advantageous for the production of the heat-sensitive layer 11. In a preferred embodiment, the first fluoropolymer accounts for 22% to 37%, and the second fluoropolymer accounts for 6% to 22% by volume.

In addition, the present invention finds that the second fluoropolymer can have a similar or the same technical effect as long as it contains the core structure the same as that of the first fluoropolymer. More specifically, if the first fluoropolymer is polyvinylidene difluoride, the second fluoropolymer is represented by a structural formula (I):

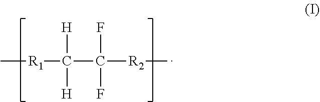

In the structural formula (I), a repeating unit is —CH₂CF₂— connected to two functional groups (i.e., R₁ and R₂), and is the core structure of the second fluoropolymer. R₁ and R₂ are selected from the group consisting of CH₂, CF₂, CHF, C₂HF₃, C₂H₂F₂, C₂H₃F, C₂H₄, and C₂F₄. R₁ is different from R₂. For example, if R₁ is CH₂, R₂ is selected from the group consisting of CF₂, CHF, C₂HF₃, C₂H₂F₂, C₂H₃F, C₂H₄, and C₂F₄. “n” is the repeating number of the repeating unit, and is at least 9000. In an embodiment, the second fluoropolymer may also be polyvinylidene difluoride, and therefore R₁ is CF₂ and R₂ is CH₂.

Moreover, the difference in flowability between the first fluoropolymer and the second fluoropolymer of the present invention can be adjusted to an appropriate range. The difference in flowability can be described by melt flow index, i.e., melt flow rate. The melt flow rate is defined as the weight of a polymer in unit of gram flowing in 10 minutes through a capillary, and can be used to assess the flowability of the polymer in the melted state. The melt flow index is measured at 230° C. in accordance with the standard of ASTM D1238, and the first fluoropolymer has a first melt flow index, and the second fluoropolymer has a second melt flow index lower than the first melt flow index. A difference between the first melt flow index and the second melt flow index (also referred to as “MFI difference” hereinafter) ranges from 0.1 g/10 min to 1 g/10 min. In an embodiment, the MFI difference may be 0.5 g/10 min to 1 g/10 min. In another embodiment, the MFI difference may be 0.5 g/10 min, 0.6 g/10 min, 0.7 g/10 min, 0.8 g/10 min, 0.9 g/10 min, or 1 g/10 min. For example, the first melt flow index may range from 0.8 g/10 min to 1.4 g/10 min, and the second melt flow index may range from 0.4 g/10 min to 0.7 g/10 min. With the proper proportion, the low flowability of the second fluoropolymer can compensate for the influence of the high flowability of the first fluoropolymer while simultaneously improving the electrical characteristics of the heat-sensitive layer 11.

In addition, the polymer matrix of the present invention may further include a third fluoropolymer. The third fluoropolymer is selected from the group consisting of polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, vinylidene fluoride-hexafluoropropylene-tetrafluoroethylene terpolymer, and any combination thereof. The melting point of the third fluoropolymer is much higher than that of the first fluoropolymer and the second fluoropolymer. For example, the melting points of the first fluoropolymer and the second fluoropolymer range from 170° C. to 186° C., and the melting point of the third fluoropolymer ranges from 320° C. to 335° C. If the environmental temperature is higher than the melting points of the first fluoropolymer and the second fluoropolymer but lower than the melting point of the third fluoropolymer, both the first fluoropolymer and the second fluoropolymer melt but the third fluoropolymer does not. In this way, particles of the third fluoropolymer remain in the solid state, and are uniformly dispersed in the heat-sensitive layer 11, thereby forming nucleation sites for the fluoropolymers which re-crystalize. It is favorable to recrystallization of the fluoropolymers. Moreover, deformation of the third fluoropolymer is less severe, when compared to the first and second fluoropolymers, under high temperature condition because of its high melting temperature, by which the structure of the heat-sensitive layer 11 is stabilized by the third fluoropolymer and does not deform severely. In an embodiment, the third fluoropolymer is polytetrafluoroethylene; and the total volume of the heat-sensitive layer is calculated as 100%, and the third fluoropolymer accounts for 4% to 6% by volume.

As for the conductive filler, it includes at least one metal compound besides carbon black so that the electrical conduction of the over-current protection device 10 can be enhanced. The metal compound is selected from the group consisting of tungsten carbide, titanium carbide, vanadium carbide, zirconium carbide, niobium carbide, tantalum carbide, molybdenum carbide, hafnium carbide, titanium boride, vanadium boride, zirconium boride, niobium boride, molybdenum boride, hafnium boride, zirconium nitride, and any combination thereof.

Besides the aforementioned polymer matrix and conductive filler, the heat-sensitive layer 11 further includes an inner filler. The inner filler is selected from the group consisting of barium titanate (BaTiO₃), strontium titanate (SrTiO₃), calcium titanate (CaTiO₃), and any combination thereof. More specifically, the present invention does not include any conventional flame retardant (e.g., boron nitride, aluminum nitride, aluminium oxide, or magnesium hydroxide), but uses a compound with perovskite structure (i.e., the above BaTiO₃, SrTiO₃, and CaTiO₃). The compound with perovskite structure exhibits a better dielectric property, and offers a flame retardant effect better than the conventional one when combined with the first fluoropolymer and the second fluoropolymer, thereby further enhancing the voltage endurance capability of the over-current protection device 10.

Besides the improvement of the material composition, the over-current protection device 10 of the present invention may have different sizes. Please refer to FIG. 2, which shows the top view of the over-current protection device 10 shown in FIG. 1. The over-current protection device 10 has a length A and a width B, and the top-view area “A×B” of the over-current protection device 10 is substantially equivalent to the top-view area of the heat-sensitive layer 11. The heat-sensitive layer 11 may have a top-view area ranging from 4 mm² to 72 mm² based on different products having different sizes. For example, the top-view area “A×B” may be 2×2 mm², 4×4 mm², 5×5 mm², 5.1×6.1 mm², 5×7 mm², 7.62×7.62 mm², 8.2×7.15 mm², 7.3×9.5 mm², or 7.62×9.35 mm². In addition, the total thickness of the over-current protection device 10 (i.e., the total thickness of the top metal layer 12, the heat-sensitive layer 11, and the bottom metal layer 13) ranges from 0.5 mm to 0.6 mm. For example, the top-view area of the over-current protection device 10 may be 35 mm² (i.e., 5×7 mm²), and the thickness of it may be 0.55 mm. In another embodiment, the top-view area of the over-current protection device 10 is 25 mm² (i.e., 5×5 mm²), and the thickness of it is 0.5 mm. It is understood that the present invention can apply to any size of the over-current protection device 10 described above to achieve the same technical effect. The over-current protection device 10 can be processed into different device types commonly used in the industry, such as surface-mount device (SMD), axial-leaded device (ALD), radial-leaded device (RLD), or other device types, depending on the requirements.

From the above, the over-current protection device 10 of the present invention can include many excellent electrical characteristics, and these electrical characteristics can be verified in the following tests: thermal shock test, trip jump test, cycle life test, and thermal derating effect test.

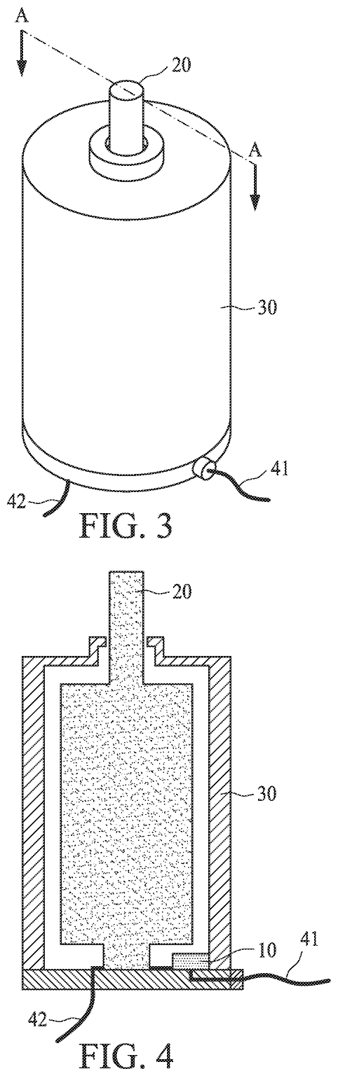

In the thermal shock test, the over-current protection device 10 of the present invention has a resistance change ranging from 0.0007Ω to 0.0021Ω when exposed to thermal shock. More specifically, a single cycle (i.e., one cycle) of the thermal shock includes the following steps: placing the over-current protection device 10 of the present invention in the environment at −40° C. for 30 minutes, followed by placing the same in the environment at 85° C. for 30 minutes. In this way, the impact of alternating low temperature (−40° C.) and high temperature (85° C.) on the electrical resistance can be assessed through cycles of thermal shock. The resistance change refers to the change in electrical resistance value between the resistance measured before the thermal shock test and the resistance measured after the thermal shock test. More specifically, the over-current protection device 10 has an initial electrical resistance before any test; the over-current protection device 10 has a first electrical resistance when cooled back to room temperature after the thermal shock from −40° C. to 85° C. for 300 cycles; and the resistance change is obtained by subtracting the initial electrical resistance from the first electrical resistance. Under the same test condition, the resistance change of the conventional over-current protection device is larger than 0.004Ω, which is much larger than the maximum resistance change (i.e., 0.0021Ω) of the present invention. Obviously, the over-current protection device 10 of the present invention can maintain excellent electrical resistance stability in the untripped temperature range, and consequently, the current flow is less affected by the temperature fluctuation during normal operation. In order to further ensure the electrical resistance stability of the over-current protection device 10, another impact (i.e., application of a specific power) is applied to the over-current protection device 10 after the thermal shock. More specifically, the over-current protection device 10 has an electrical resistance ranging from 0.02Ω to 0.03Ω when cooled back to room temperature after the thermal shock from −40° C. to 85° C. for 300 cycles and being applied at 24V/40 A for 3 minutes. In contrast, the electrical resistance of the conventional over-current protection device is higher than 0.34Ω after the above-said another impact. From the above, it can be further confirmed that the over-current protection device 10 of the present invention can maintain excellent electrical resistance stability under various stresses, such as those related to temperature and applied power, as described above. It is worth mentioning that the resistance stability of the over-current protection device in untripped state is crucial and demands stricter requirements in certain industries, such as the automotive market for motors. Please refer to FIG. 3 and FIG. 4.

FIG. 3 shows a three-dimensional view of basic components of a motor. FIG. 4 shows a cross-sectional view of the motor along the line AA shown in FIG. 3. The motor includes a rotor module 20, a stator module 30, and electrical connection terminals (i.e., a first wire 41 and a second wire 42). The rotor module 20 has a shaft, a rotor core, a rotor winding, and other components (not shown). The stator module 30 has a stator core, a stator winding, brushes, and other non-rotating parts (not shown). The external power source can continuously supply power to the motor through the electrical connection terminals. When the current flows through the stator module 30, the stator winding within the stator module 30 generates a rotating magnetic field while the rotor winding within the rotor module 20 correspondingly generates an opposing induced magnetic field. The interaction of these two magnetic fields drives the rotation of the rotor. Under normal conditions, as the external power supply continues to provide power to the stator module 30, the rotor module 20 correspondingly continues to rotate, thereby driving the operation of external components connected to the motor. However, conditions such as excessive motor load, malfunction of the external components, or bearing damage can lead to locked-rotor condition. That is, the rotor module 20 ceases to rotate while the stator module 30 continues to receive the supply of external power. In this situation, in order to drive the rotor module 20 to rotate, the current flowing through the stator module 30 (i.e., the locked-rotor current) would be significantly higher than the current before the rotor module 20 was locked. If this condition prolongs, it can lead to the burning of the winding. In view of this, the over-current protection device 10 of the present invention can be installed at the bottom of the casing of the stator module 30 to prevent motor damage, as shown in FIG. 4. When the motor is locked (resulting in high current or excessive temperature), the over-current protection device 10 can be triggered into a high electrical resistance state, cutting off the flow of current between the external power source and the stator module 30. More importantly, when the motor is not locked, the over-current protection device 10 can maintain a stable low electrical resistance state even under the high temperature generated during the motor's normal operation, ensuring that it does not affect the motor's normal operation and, consequently, ensures good driving quality.

In the trip jump test, the over-current protection device 10 of the present invention has a first resistance-jump ratio ranging from 1.43 to 1.55. More specifically, the over-current protection device 10 has an initial electrical resistance before any test, and has a second electrical resistance when cooled back to room temperature after being applied at 24V/40 A for 3 minutes. The first resistance-jump ratio is obtained by dividing the second electrical resistance by the initial electrical resistance. Continuous application of a specific power (24V/40 A) can trip the over-current protection device 10 of the present invention. In this way, the first resistance-jump ratio can be used to assess the resistance recovery capability of the over-current protection device 10 of the present invention after at least one trip event. In contrast, the first resistance-jump ratio of the conventional over-current protection device is at least 1.58, which is higher than the maximum of that (i.e., 1.55) of the over-current protection device 10 of the present invention. It suggests that the resistance recovery capability of the over-current protection device 10 of the present invention is better, and it can recover to a lower electrical resistance state after the trip event. Furthermore, when the over-current protection device 10 trips, the current cannot be completely cut off and there is still a leakage current passing therethrough. The power dissipation can be calculated based on the amount of the leakage current. The power dissipation of the over-current protection device 10 of the present invention ranges from 1.5 W to 1.6 W, and the power dissipation of the conventional over-current protection device is at least 1.63. From this, it is understood that, in comparison with conventional over-current protection device, the over-current protection device 10 of the present invention possesses better resistance recovery capability while having the advantage of lower power dissipation.

In the cycle life test, the over-current protection device 10 of the present invention has a second resistance-jump ratio ranging from 2.46 to 2.94. More specifically, the over-current protection device 10 has an initial electrical resistance before any test, and has a third electrical resistance when cooled back to room temperature after a cycle life test for 100 cycles. The second resistance-jump ratio is obtained by dividing the third electrical resistance by the initial electrical resistance. One cycle of the aforementioned cycle life test includes applying voltage/current at 36V/30 A for 10 seconds and turning it off for 60 seconds (i.e., on: 10 seconds; off: 60 seconds), and 100 cycles above are performed on the over-current protection device 10. The cycle life test can be used to assess not only the endurance of the over-current protection device 10 (i.e., whether it is burnt out) but also its resistance recovery capability through the second resistance-jump ratio after multiple trip events in the test. In contrast, the conventional over-current protection device is burnt out in the cycle life test, and the second resistance-jump ratio cannot be calculated, suggesting that the over-current protection device 10 of the present invention has better endurance while possessing better resistance recovery capability than those of the conventional device.

In the thermal derating effect test, the over-current protection device 10 has a thermal derating ratio of trip current ranging from 0.6 to 0.7. More specifically, the thermal derating ratio of trip current is defined as a value by dividing a required trip current of the over-current protection device 10 under 85° C. by a required trip current of the over-current protection device 10 under 23° C. The thermal derating effect test is used to compare the difference between the required trip currents of the over-current protection device 10 at different environmental temperatures, and it can be used to assess the impact of high temperature on operational performance. Ideally, the user would expect the same (or similar) value of the required trip currents of the over-current protection device 10 under different environmental temperatures so that the over-current protection device 10 can perform its function of over-current protection at a stable preset current (i.e., the preset required trip current), which is beneficial to operational convenience. In contrast, the thermal derating ratio of the conventional over-current protection device is lower than 0.6, which is lower than the minimum of that of the over-current protection device 10 of the present invention. From the above, the required trip current of the over-current protection device 10 of the present invention is less affected by temperature change, and can perform its function of over-current protection at a stable preset current, which is beneficial to operational convenience.

As described above, the present invention allows the over-current protection device 10 to exhibit excellent electrical characteristics under high temperature. It can be verified according to the experimental data in Table 1 to Table 6 as shown below.

TABLE 1
Major polymers of the polymer matrix.

| Polymer | Melt flow index (g/10 min) | Melting point (° C.) |
|---|---|---|
| PVDF-1 | 1.1 | 185 |
| PVDF-2 | 0.55 | 171 |
| PVDF-3 | 3 | 168 |

TABLE 2
Volume percentage (vol %) of the heat-sensitive layer.

| Group | PVDF-1 | PVDF-2 | PVDF-3 | PTFE | BaTiO₃ | CB | WC |
|---|---|---|---|---|---|---|---|
| E1 | 41 | 2 | | 5 | 10 | 2 | 40 |
| E2 | 37 | 6 | | 5 | 10 | 2 | 40 |
| E3 | 29 | 14 | | 5 | 10 | 2 | 40 |
| E4 | 22 | 22 | | 5 | 10 | 2 | 40 |
| E5 | 14 | 29 | | 5 | 10 | 2 | 40 |
| C1 | 43 | 0 | | 5 | 10 | 2 | 40 |
| C2 | 0 | 0 | 43 | 5 | 10 | 2 | 40 |
| C3 | 0 | 14 | 29 | 5 | 10 | 2 | 40 |

Table 1 shows the major polymers in the polymer matrix, that is, three types of polyvinylidene difluoride (PVDF) referred to as first polyvinylidene difluoride (PVDF-1), second polyvinylidene difluoride (PVDF-2), and third polyvinylidene difluoride (PVDF-3) hereinafter. In terms of melting point, the melting points of PVDF-1, PVDF-2, and PVDF-3 are 185° C., 171° C., and 168° C., respectively. The melt flow index is measured in accordance with the standard of ASTM D1238. PVDF-2 has the lowest melt flow index, that is, 0.55 g/10 min. In addition, the weight average molecular weight of PVDF-1 is 350000 g/mol; the weight average molecular weight of PVDF-2 is 880000 g/mol; and the weight average molecular weight of PVDF-3 is 290000 g/mol. PVDF-2 has a higher weight average molecular weight, which not only reduces the material's inherent flow characteristics but also suggests that a higher proportion of the α-phase structure in this type of polyvinylidene fluoride. It should be understood that polyvinylidene fluoride has various crystalline phases (such as α-phase, β-phase, γ-phase, δ-phase, and ε-phase), among which the α-phase polyvinylidene fluoride possesses the most stable structure.

Please refer to Table 2. Table 2 shows the volume percentage composition of the heat-sensitive layer in accordance with the embodiments (E1-E5) of the present disclosure and the comparative examples (C1-C3). The first column in Table 1 shows test groups E1-C3 from top to bottom. The first row in Table 1 shows various materials used for the heat-sensitive layer from left to right, that is, polyvinylidene fluoride (PVDF-1, PVDF-2, and PVDF-3), polytetrafluoroethylene (PTFE), barium titanate (BaTiO₃), carbon black (CB), and tungsten carbide (WC). Each group replaces the traditional flame retardant (such as magnesium hydroxide) typically used in over-current protection devices with barium titanate. In order to enhance electrical conduction, tungsten carbide is the major constituent and carbon black is the minor constituent of the conductive filler. The combination of tungsten carbide and carbon black in such proportion may also be referred to as a type of LR (low resistivity) system's conductive fillers.

In the embodiments E1 to E5 of the present invention, the major constituent of the polymer matrix are two types of PVDF (i.e., PVDF-1 and PVDF-2), and the minor constituent of the polymer matrix is PTFE. Since PTFE has a much higher melting point (about 330° C.) than that of PVDF, the proportion of PTFE must not be too high to avoid affecting the processability and other unexpectedly adverse issues to the trip event of the over-current protection device. The proportion of PVDF relative to PTFE needs to be carefully controlled. It is noted that the major constituent of the polymer matrix has two types of PVDF with two different physical/chemical properties, rather than a single type of PVDF, which adds greater complexity to the formulation design. Through experiments, the optimal ratio of PVDF to PTFE of the present invention is approximately 9:1. Therefore, the combined volume percentage of PVDF-1 and PVDF-2 is about 43%, and the volume percentage of PTFE is 5%. It is noted that considering the measurement error and according to the practical use, the permissible error tolerance for the major constituent (PVDF-1 and PVDF-2) in the polymer matrix is about 5% by volume, for which the same technical effect can be achieved. For example, the combined volume percentage of PVDF-1 and PVDF-2 can be 48%; calculated according to the proportion of the embodiment E1 of the present invention, PVDF-1 accounts for about 46% by volume, while PVDF-2 accounts for about 2% by volume; calculated according to the proportion of the embodiment E2 of the present invention, PVDF-1 accounts for about 41% by volume, while PVDF-2 accounts for about 7% by volume; calculated according to the proportion of the embodiment E3 of the present invention, PVDF-1 accounts for about 32% by volume, while PVDF-2 accounts for about 16% by volume; calculated according to the proportion of the embodiment E4 of the present invention, PVDF-1 accounts for about 24% by volume, while PVDF-2 accounts for about 24% by volume; and calculated according to the proportion of the embodiment E5 of the present invention, PVDF-1 accounts for about 16% by volume, while PVDF-2 accounts for about 32% by volume. Alternatively, the combined volume percentage of PVDF-1 and PVDF-2 can be 38%, and the proportion of PVDF-1 to PVDF-2 of each embodiment can be calculated in the same way as described above.

In the comparative examples C1 to C3, the major constituent of the polymer matrix consists of PVDF, and the minor constituent of the polymer matrix is PTFE. The major constituent of the polymer matrix in the comparative examples C1 and C2 consists of a single type of PVDF, and the major constituent of the polymer matrix in the comparative example C3 consists of two types of PVDF (i.e., PVDF-2 and PVDF-3). Conventionally, a single type of PVDF is often used for improving the over-current protection device (i.e., comparative examples C1 and C2), but it exhibits poor electrical characteristics. Even when two types of PVDF are used for improving the over-current protection device (i.e., comparative example C3), the same issue exists. Subsequent tests will demonstrate that the embodiments E1 to E5 of the present invention have better performance than the comparative examples C1 to C3.

The manufacturing process of the embodiments E1 to E5 and the comparative examples C1 to C3 is described below. According to the composition shown in Table 2, materials are prepared and put into HAAKE twin screw blender for blending. The blending temperature is 215° C., the time for pre-mixing is 3 minutes, and the blending time is 15 minutes. The conductive polymer after being blended is pressed into a sheet by a hot press machine at a temperature of 210° C. and a pressure of 150 kg/cm². The sheet is then cut into pieces of about 20 cm×20 cm, and two nickel-plated copper foils are laminated to two sides of the sheet with the hot press machine at a temperature of 210° C. and a pressure of 150 kg/cm², by which a three-layered structure is formed. Then, the sheet with the nickel-plated copper foils is punched into PTC chips, each of which is the over-current protection device. Each sample of the over-current protection device has the length of 5 mm and the width of 7 mm (i.e., top-view area is 35 mm²), and the thickness thereof is 0.55 mm. Then, the PTC chips of the embodiments and comparative examples are subjected to electron beam irradiation of 150 kGy (irradiation dose can be adjusted depending on the requirement). After irradiation, the following measurements are performed by taking fifteen PTC chips as samples to be tested for each of the groups.

Table 3 to Table 6 show the results of thermal shock test, trip jump test, cycle life test, and thermal derating effect test.

TABLE 3
Thermal shock test.

| | Rᵢ | R_{300 C} | Delta R | R_{300 C}_{_{—}}ₜᵣᵢₚ | |
|---|---|---|---|---|---|
| Group | (Ω) | (Ω) | (Ω) | (Ω) | Rⱼᵤₘₚ |
| E1 | 0.00520 | 0.00724 | 0.00204 | 0.02972 | 4.11 |
| E2 | 0.00520 | 0.00601 | 0.00082 | 0.02590 | 4.31 |
| E3 | 0.00549 | 0.00644 | 0.00095 | 0.02267 | 3.52 |
| E4 | 0.00551 | 0.00684 | 0.00133 | 0.02733 | 4.00 |
| E5 | 0.00621 | 0.00690 | 0.00070 | 0.02864 | 4.15 |
| C1 | 0.00546 | 0.01596 | 0.01050 | 0.05610 | 3.52 |
| C2 | 0.00908 | 0.01816 | 0.00908 | 0.03472 | 1.91 |
| C3 | 0.01003 | 0.01469 | 0.00466 | 0.06885 | 4.69 |

As shown in Table 3, the first row shows items to be tested from left to right.

“Rᵢ” refers to the initial electrical resistance of the over-current protection device at room temperature.

“R_{300C}” refers to the electrical resistance of the over-current protection device when it is cooled back to room temperature after the thermal shock from −40° C. to 85° C. for 300 cycles. “Delta R” can be calculated by subtracting Rᵢ from R_{300C}. Delta R is the resistance change as described above.

“R_{300C_trip}” refers to the electrical resistance of the over-current protection device when it is cooled back to room temperature after the aforementioned thermal shock and being applied at 24V/40 A for 3 minutes. Rⱼᵤₘₚ can be calculated by dividing R_{300C_trip} by R_{300C}.

In the embodiments E1 to E5 of the present invention, Rᵢ ranges from 0.00520Ω to 0.00621Ω, and R_{300C} ranges from 0.00601Ω to 0.00724Ω. In contrast, in the comparative examples C1 to C3 of the present invention, Rᵢ ranges from 0.00546Ω to 0.01003Ω, and R_{300C} ranges from 0.01469Ω to 0.01816Ω. From the above, it can be seen that the initial resistance values (Rᵢ) of the embodiments E1 to E5 of the present invention remain within a lower range when compared to the comparative examples C1 to C3. After thermal shock, the difference in electrical resistance becomes more pronounced. The values of R_{300C} in the embodiments E1 to E5 of the present invention are significantly smaller than those in the comparative examples C1 to C3. Furthermore, regarding the resistance change between R_{300C} and Rᵢ, Delta R of the embodiments E1 to E5 of the present invention ranges from 0.00070Ω to 0.00204Ω, and that of the comparative examples C1 to C3 ranges from 0.00466Ω to 0.01050Ω. That is, when the device is exposed to temperature shock, the resistance change of the comparative examples C1 to C3 is at least twice higher than that of the embodiments E1 to E5 of the present invention. This indicates that, when compared to the comparative examples C1 to C3, the electrical resistance of the embodiments E1 to E5 of the present invention is less affected by environmental temperature in the untripped state. The electrical resistance of the embodiments E1 to E5 of the present invention is more thermally stable, which allows the over-current protection device 10 to maintain a larger current flow before the trip action is triggered.

To further verify the electrical resistance stability of the embodiments E1 to E5 of the present invention, a specific power is applied to trip the over-current protection device after the thermal shock (i.e., the previously mentioned 24V/40 A applied for 3 minutes). That is, the impact of the thermal shock is performed first, followed by another impact of application of the specific power. In this way, the electrical resistance stability of the over-current protection device can be observed after two types of impact. As shown in Table 3, R_{300C_trip} of the embodiments E1 to E5 of the present invention ranges from 0.02267Ω to 0.02972Ω, and R_{300C_trip} of the comparative examples C1 to C3 ranges from 0.03472Ω to 0.06885Ω. The values of R_{300C_trip} in the embodiments E1 to E5 of the present invention are significantly smaller than those in the comparative examples C1 to C3. Moreover, they can differ by up to three times at most, as seen in the embodiment E3 and the comparative example C3. The above results demonstrate that the embodiments E1 to E5 of the present invention can still maintain good resistance stability, even when they are subjected to various types of impact.

TABLE 4
Trip jump test.

| | | | | Power | Power |
|---|---|---|---|---|---|
| | Rᵢ | Rₜᵣᵢₚ | Rₜᵣᵢₚ/ | dissipation | dissipation/area |
| Group | (Ω) | (Ω) | Rᵢ | (W) | (W/mm²) |
| E1 | 0.00560 | 0.00807 | 1.43 | 1.59 | 0.045 |
| E2 | 0.00510 | 0.00776 | 1.52 | 1.58 | 0.045 |
| E3 | 0.00523 | 0.00808 | 1.54 | 1.52 | 0.043 |
| E4 | 0.00540 | 0.00836 | 1.55 | 1.55 | 0.044 |
| E5 | 0.00590 | 0.00891 | 1.51 | 1.6 | 0.046 |
| C1 | 0.00540 | 0.00861 | 1.59 | 1.66 | 0.047 |
| C2 | 0.00930 | 0.01605 | 1.74 | 1.73 | 0.049 |
| C3 | 0.01010 | 0.01592 | 1.58 | 1.63 | 0.047 |

As shown in Table 4, the first row shows items to be tested from left to right.

“Rᵢ” refers to the initial electrical resistance of the over-current protection device at room temperature.

“Rₜᵣᵢₚ” refers to the electrical resistance of the over-current protection device when it is cooled back to room temperature after being applied at 24V/40 A for 3 minutes. Accordingly, Rₜᵣᵢₚ/Rᵢ can be calculated, and this is the first resistance-jump ratio as previously mentioned.

“Power dissipation” refers to the product of leakage current and applied voltage. Accordingly, power dissipation per unit area can be calculated.

In the embodiments E1 to E5 of the present invention, Rᵢ ranges from 0.00510Ω to 0.00590Ω, and Rₜᵣᵢₚ ranges from 0.00776Ω to 0.00891Ω. In contrast, in the comparative examples C1 to C3, Rᵢ ranges from 0.00540Ω to 0.01010Ω, and Rₜᵣᵢₚ ranges from 0.00861Ω to 0.01605Ω. From the above, both Rᵢ and Rₜᵣᵢₚ of the embodiments E1 to E5 remain in the lower value range when compared to the comparative examples C1 to C3. Furthermore, when analyzing the resistance-jump ratio (i.e., Rₜᵣᵢₚ/Rᵢ), the difference between the embodiments and comparative examples becomes more significant. In the embodiments E1 to E5 of the present invention, Rₜᵣᵢₚ/Rᵢ maintains in the range from 1.43 to 1.55. However, in the comparative examples C1 to C3, Rₜᵣᵢₚ/Rᵢ ranges from 1.58 to 1.74. Even though the comparative example C3 has the most stable electrical resistance among the comparative examples, its Rₜᵣᵢₚ/Rᵢ is still higher than all the embodiments E1 to E5 of the present invention. Moreover, the embodiments E1 to E5 of the present invention have better performance in cutting off the current flow. In the embodiments E1 to E5, the leakage current maintains in the lower range, resulting in lower power dissipation (1.52 W to 1.6 W) when compared to the comparative examples C1 to C3.

TABLE 5
Cycle life test.

| | Rᵢ | ρ | R_{500 C} | R_{300 C} | R_{100 C} | |
|---|---|---|---|---|---|---|
| Group | (Ω) | (Ω · cm) | (Ω) | (Ω) | (Ω) | R_{100 C}/Rᵢ |
| E1 | 0.0060 | 0.0379 | 0.0188 | 0.01990 | — | — |
| E2 | 0.0053 | 0.0335 | 0.0149 | 0.0201 | 0.01293 | 2.46 |
| E3 | 0.0054 | 0.0344 | 0.0146 | 0.0163 | 0.01443 | 2.67 |
| E4 | 0.0055 | 0.0353 | 0.0200 | 0.0218 | 0.01463 | 2.64 |
| E5 | 0.0062 | 0.0393 | 0.0274 | 0.0265 | 0.01817 | 2.94 |
| C1 | 0.0053 | 0.0339 | — | — | — | — |
| C2 | 0.0092 | 0.0585 | — | — | — | — |
| C3 | 0.0105 | 0.0671 | — | — | — | — |

It should be noted that the cycle life test conducted in this experiment includes three test sets (referred to as the first cycle life test, the second cycle life test, and the third cycle life test hereinafter) with different applied powers and cycle numbers. The first cycle life test is performed at a power of 24V/40 A for 500 cycles, the second cycle life test is performed at a power of 30V/30 A for 300 cycles, and the third cycle life test is performed at a power of 36V/30 A for 100 cycles.

As shown in Table 5, the first row shows items to be tested from left to right.

“Rᵢ” refers to the initial electrical resistance of the over-current protection device at room temperature. Moreover, the electrical resistance formula is ρ=R×A/L, where “R” is electrical resistance, “L” is length (thickness), and “A” is cross sectional area. Accordingly, the electrical resistivity of ρ can be calculated corresponding to Rᵢ.

“R_{500C}” refers to the electrical resistance of the over-current protection device when it is cooled back to room temperature after the first cycle life test. “R_{300C}” refers to the electrical resistance of the over-current protection device when it is cooled back to room temperature after the second cycle life test. “R_{100C}” refers to the electrical resistance of the over-current protection device when it is cooled back to room temperature after the third cycle life test. R_{100C}/Rᵢ is the second resistance-jump ratio as previously mentioned.

In the embodiments E1 to E5 of the present invention, Rᵢ ranges from 0.0053Ω to 0.0062Ω, and, in the comparative examples C1 to C3, Rᵢ ranges from 0.0053Ω to 0.0105Ω. According to the above-mentioned electrical resistance formula, the embodiments E1 to E5 of the present invention have the electrical resistivities (ρ) ranging from 0.0335 Ω·cm to 0.0393 Ω·cm, and the comparative examples C1 to C3 have the electrical resistivities (ρ) ranging from 0.0339 Ω·cm to 0.0671 Ω·cm. Likewise, both the initial electrical resistance (Rᵢ) and electrical resistivity (ρ) of the embodiments E1 to E5 remain in the lower value range when compared to the comparative examples C1 to C3, indicating that the embodiments E1 to E5 have better capability for electrical conduction. In the cycle life test, the embodiments E1 to E5 of the present invention pass both the first cycle life test and the second cycle life test without burnout. As for the third cycle life test, only the embodiments E2 to E5 of the present invention pass without burnout, while the embodiment E1 of the present invention is burnt out, so there is no data of R_{100C} for it. The embodiments E2 to E5 of the present invention can withstand the high voltage and high power of the third cycle life test, and the second resistance-jump ratio (R_{100C}/Rᵢ) ranges from 2.46 to 2.94. In contrast, the comparative examples C1 to C3 cannot pass the first cycle life test, the second cycle life test, and the third cycle life test. In other words, the comparative examples C1 to C3 are burnt out in the first cycle life test, the second cycle life test, and the third cycle life test, and there are no data of R_{500C}, R_{300C} and R_{100C}. It is noted that the comparative examples C1 and C3 are not burnt out at the 300^{th} cycle of the first cycle life test, but their electrical resistances have increased to 0.0315Ω and 0.07177Ω (not shown in Table 5), respectively. These values are much higher than those of all the embodiments E1 to E5 at the 500^{th} cycle. In addition, the comparative examples C2 and C3 are burnt out after only 100 cycles in the second cycle life test, which is less than half of the predetermined cycle number (i.e., 300 cycles). Nevertheless, in the comparative examples C1 to C3, the electrical resistivity is higher and the voltage endurance capability is much poorer.

TABLE 6
Thermal derating effect test.

| | I-T_{23° C.} | I-T_{23° C.}/area | I-T_{85° C.} | I-T_{85° C.}/area | I-T_{85° C.}/ |
|---|---|---|---|---|---|
| Group | (A) | (A/mm²) | (A) | (A/mm²) | I-T_{23° C.} |
| E1 | 7.42 | 0.212 | 4.56 | 0.130 | 0.615 |
| E2 | 7.36 | 0.210 | 4.56 | 0.130 | 0.620 |
| E3 | 6.92 | 0.198 | 4.37 | 0.125 | 0.632 |
| E4 | 6.72 | 0.192 | 4.22 | 0.121 | 0.628 |
| E5 | 6.32 | 0.181 | 4.20 | 0.120 | 0.665 |
| C1 | 7.42 | 0.212 | 4.390 | 0.125 | 0.592 |
| C2 | 4.68 | 0.134 | 2.08 | 0.059 | 0.444 |
| C3 | 4.88 | 0.139 | 2.22 | 0.063 | 0.455 |

As shown in Table 6, the first row shows items to be tested from left to right.

“I-T_{23° C.}” and “I-T_{85° C.}” refer to trip currents of the over-current protection device under the environmental temperature of 23° C. and 85° C., respectively. Accordingly, “I-T_{23° C.}/area” and “I-T_{85° C.}/area” can be calculated, each of which refers to the trip current per unit area of the over-current protection device.

“I-T_{85° C.}/I-T_{23° C.}” refers to the thermal derating ratio as previously mentioned. As described above, the over-current protection device requires different trip currents for triggering the trip action under different environmental temperatures. It is understood that if the over-current protection device is placed under lower temperature, the electrical resistance of it is lower and the required trip current correspondingly is higher. If the over-current protection device is placed under higher temperature, the electrical resistance of it is higher and the required trip current correspondingly is lower. Thus, the thermal derating ratio (I-T_{85° C.}/I-T_{23° C.}) can be used to assess the impact of high temperature on the device's operational performance. The thermal derating ratio (I-T_{85° C.}/I-T_{23° C.}) of the embodiments E1 to E5 of the present invention ranges from 0.615 to 0.665, and the thermal derating ratio (I-T_{85° C.}/I-T_{23° C.}) of the comparative examples C1 to C3 ranges from 0.444 to 0.592. Apparently, the thermal derating ratio (I-T_{85° C.}/I-T_{23° C.}) of the embodiments E1 to E5 of the present invention is closer to 1, indicating that the required trip current for the embodiments E1 to E5 of the present invention is more stable under different environmental temperatures. In contrast, in the comparative examples C1 to C3, the thermal derating ratio (I-T_{85° C.}/I-T_{23° C.}) can be down to 0.444, indicating that the required trip current for the comparative examples C1 to C3 has decreased by more than half under the environmental temperature of 85° C., which is quite unstable. From the above, it is clear that within the temperature range where the device remains untripped, the embodiments E1 to E5 of the present invention provide a more stable over-current protection function, enhancing operational convenience.

The above-described embodiments of the present invention are intended to be illustrative only. Numerous alternative embodiments may be devised by persons skilled in the art without departing from the scope of the following claims.

What is claimed is:

1. An over-current protection device, comprising:
an electrode layer having a top metal layer and a bottom metal layer; and
a heat-sensitive layer contacting the top metal layer and the bottom metal layer, and being laminated therebetween, wherein the heat-sensitive layer exhibits a positive temperature coefficient (PTC) characteristic and comprises:
a polymer matrix comprising a first fluoropolymer and a second fluoropolymer, wherein the weight average molecular weight of the second fluoropolymer ranges from 630000 g/mol to 1100000 g/mol; and
a conductive filler dispersed in the polymer matrix, thereby forming an electrically conductive path in the heat-sensitive layer.

2. The over-current protection device of claim 1, wherein the total volume of the heat-sensitive layer is calculated as 100%, and the first fluoropolymer accounts for 12% to 42% and the second fluoropolymer accounts for 1% to 31% by volume.

3. The over-current protection device of claim 1, wherein the second fluoropolymer is represented by a structural formula (I): 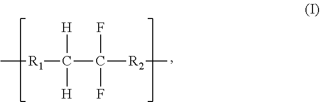
wherein:
R₁ and R₂ are selected from the group consisting of CH₂, CF₂, CHF, C₂HF₃, C₂H₂F₂, C₂H₃F, C₂H₄, and C₂F₄;
R₁ is different from R₂; and
n is at least 9000.

4. The over-current protection device of claim 1, wherein the weight average molecular weight of the first fluoropolymer ranges from 250000 g/mol to 490000 g/mol.

5. The over-current protection device of claim 1, wherein the first fluoropolymer has a first melt flow index, and the second fluoropolymer has a second melt flow index lower than the first melt flow index, wherein a difference between the first melt flow index and the second melt flow index ranges from 0.1 g/10 min to 1 g/10 min.

6. The over-current protection device of claim 5, wherein the first melt flow index ranges from 0.8 g/10 min to 1.4 g/10 min, and the second melt flow index ranges from 0.4 g/10 min to 0.7 g/10 min.

7. The over-current protection device of claim 1, wherein the first fluoropolymer is polyvinylidene difluoride.

8. The over-current protection device of claim 1, wherein the polymer matrix further comprises a third fluoropolymer selected from the group consisting of polytetrafluoroethylene, ethylene-tetrafluoroethylene copolymer, tetrafluoroethylene-hexafluoro-propylene copolymer, perfluoroalkoxy modified tetrafluoroethylenes, poly(chlorotri-fluorotetrafluoroethylene), vinylidene fluoride-tetrafluoroethylene copolymer, tetrafluoroethylene-perfluorodioxole copolymer, vinylidene fluoride-hexafluoropropylene copolymer, vinylidene fluoride-hexafluoropropylene-tetrafluoroethylene terpolymer, and any combination thereof.

9. The over-current protection device of claim 8, wherein the third fluoropolymer is polytetrafluoroethylene, wherein the total volume of the heat-sensitive layer is calculated as 100%, and polytetrafluoroethylene accounts for 4% to 6% by volume.

10. The over-current protection device of claim 1, wherein the heat-sensitive layer further comprises an inner filler selected from the group consisting of BaTiO₃, SrTiO₃, CaTiO₃, and any combination thereof.

11. The over-current protection device of claim 1, wherein the conductive filler comprises carbon black and at least one metal compound, and the metal compound is selected from the group consisting of tungsten carbide, titanium carbide, vanadium carbide, zirconium carbide, niobium carbide, tantalum carbide, molybdenum carbide, hafnium carbide, titanium boride, vanadium boride, zirconium boride, niobium boride, molybdenum boride, hafnium boride, zirconium nitride, and any combination thereof.

12. The over-current protection device of claim 1, wherein the over-current protection device has a resistance change ranging from 0.0007Ω to 0.0021Ω when exposed to a thermal shock, wherein:
the over-current protection device has an initial electrical resistance;
the over-current protection device has a first electrical resistance when cooled back to room temperature after the thermal shock from −40° C. to 85° C. for 300 cycles; and
the resistance change is obtained by subtracting the initial electrical resistance from the first electrical resistance.

13. The over-current protection device of claim 12, wherein the over-current protection device has an electrical resistance ranging from 0.02Ω to 0.03Ω when cooled back to room temperature after the thermal shock from −40° C. to 85° C. for 300 cycles and being applied at 24V/40 A for 3 minutes.

14. The over-current protection device of claim 1, wherein the over-current protection device has a first resistance-jump ratio ranging from 1.43 to 1.55, wherein:
the over-current protection device has an initial electrical resistance;
the over-current protection device has a second electrical resistance when cooled back to room temperature after being applied at 24V/40 A for 3 minutes; and
the first resistance-jump ratio is obtained by dividing the second electrical resistance by the initial electrical resistance.

15. The over-current protection device of claim 14, wherein the over-current protection device has a power dissipation ranging from 1.5 W to 1.6 W when 24V/40 A is applied to the over-current protection device.

16. The over-current protection device of claim 1, wherein the over-current protection device has an electrical resistivity ranging from 0.03 Ω·cm to 0.04 Ω·cm.

17. The over-current protection device of claim 16, wherein the over-current protection device has a second resistance-jump ratio ranging from 2.46 to 2.94, wherein:
the over-current protection device has an initial electrical resistance;
the over-current protection device has a third electrical resistance when cooled back to room temperature after a cycle life test for 100 cycles; and
the second resistance-jump ratio is obtained by dividing the third electrical resistance by the initial electrical resistance.

18. The over-current protection device of claim 1, wherein the over-current protection device has a thermal derating ratio of trip current ranging from 0.6 to 0.7, wherein the thermal derating ratio of trip current is defined as a value by dividing a required trip current of the over-current protection device under 85° C. by a required trip current of the over-current protection device under 23° C.
